(19) United States
(12) Patent Application Publication
(10) Pub. No.: US 2024/0370241 A1
(43) Pub. Date: Nov. 7, 2024

(54) FUSION FOR MULTI-LAYERED COMPUTATIONAL GRAPHS

(71) Applicant: Modular ,Inc., Redwood City, CA (US)

(72) Inventors: Tim Davis, Los Altos, CA (US); Chris Lattner, Los Altos Hills, CA (US)

(21) Appl. No.: 18/650,012

(22) Filed: Apr. 29, 2024

Related U.S. Application Data
(60) Provisional application No. 63/463,483, filed on May 2, 2023.
(60) Provisional application No. 63/463,237, filed on May 1, 2023.

(51) Int. Cl. G06F 8/41

(52) U.S. Cl. CPC G06F 8/453

(57) ABSTRACT

A compilation system for compiling multi-layered graphs that improves the optimization and extensibility of computational graphs used in machine learning systems. The system receives a multi-layered computational graph comprising a modular operation graph that provides a type system and device-independent rewrites. The system generates a modular operation generator graph using sets of system and user-supplied kernels, and performs one or more fusions of two or more operations to generate an optimized modular operation generator graph having one or more fused operations. The system generates an executable object using the optimized modular operation generator graph. By employing a multi-layered computational graph representation, the system provides improved integration with the compilation system and improves user extensibility of the compilation process. The system further provides for user-supplied kernels and operations to be treated as first-class objects and receive the same optimization treatment as other first-class objects within the compilation system.

### CLAIM OF PRIORITY

This application claims the benefit of priority under 35 U.S.C. § 119(e) to U.S. Patent Application Ser. No. 63/463,237, filed on May 1, 2023, and claims the benefit of priority under 35 U.S.C. § 119 (e) to U.S. Patent Application Ser. No. 63/463,483, filed on May 2, 2023, each of which is incorporated by reference herein in its entirety.

### TECHNICAL FIELD

The present disclosure relates generally to compilers, and more specifically to compilers for computationally intensive code.

### BACKGROUND

Compliers are used to generate object code from high-level languages. It is desirable to generate optimized object code.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a data flow diagram of a kernel generation and use process, in accordance with some examples.

FIG. 2 is a collaboration diagram of a compilation system, in accordance with some examples.

FIG. 3 is an activity diagram of a kernel generation method, in accordance with some examples.

FIG. 4A is a diagram of a graph used in a graph compiler, in accordance with some examples.

FIG. 4B is a diagram of an operation of a graph of a graph compiler where the operation includes input ports and output ports, in accordance with some examples.

FIG. 5A is a collaboration diagram of a multi-layered graph compiler pipeline, in accordance with some examples.

FIG. 5B is a process flow diagram of a compilation method, in accordance with some examples.

FIG. 6A illustrates a machine-learning pipeline, according to some examples.

FIG. 6B illustrates training and use of a machine-learning program, according to some examples.

FIG. 7 is a deployment diagram of a networked compilation environment, in accordance with some examples.

FIG. 8 is an architecture diagram of a machine within which a set of instructions may be executed for causing the machine to perform any one or more of the methodologies discussed herein, in accordance with some examples.

### DETAILED DESCRIPTION

Fusion is the act of taking a set of loop operations and collapsing them into a smaller set of operations. An example of fusing two loops is shown below:
for i in range (N):
   B [i]=op1 (A [i])
for i in range (N):
   C [i]=op2 (B [i])

Two loops may be fused into a single loop
for i in range (N):
   B [i]=op1 (A [i])
   C [i]=op2 (B [i])

If there is no other uses of B, then the B vector can be elided:
for i in range (N):
   C [i]=op2 (op1 (A [i]))

In Machine Learning (ML) models, fusion occurs because models are composed of layers each one corresponds to a sequence of for loops. This model, for example, contains two layers op1 and op2:
[input]-->[op1]-->[op2]-->[output]

The two operators can be fused into a single operator:
[input]-->[op1+op2]-->[output]

When a Neural Network (NN) is trained, the NN often consists of many individual layers that are executed sequentially during inference. However, executing multiple individual layers sequentially can be computationally expensive and inefficient. Fusion helps to optimize the execution of these layers by combining them into a single operation or layer that can be executed more efficiently.

For example, if a neural network includes a convolutional layer followed by a batch normalization layer and a ReLU activation layer, these three layers could be fused into a single layer that performs all three operations in a single step. This can significantly reduce the overhead of executing each individual layer separately, leading to faster and more efficient inference.

ML systems often use models that can be represented as a series of computational graphs. These graphs can be optimized using methodologies such as, but not limited to removing redundant computation, performing device specific transforms, fusing kernels, and the like.

Fusion is a technique used in the compilation of ML models to optimize their performance on different hardware platforms, such as CPUs, GPUs, and specialized accelerators.

A graph optimizer may use a single layer of intermediate representation and condition optimizations based on what device or kernel library has been specified when the graph was initialized. However, this has its drawbacks including increased complexity in both the implementation of those passes and the extension of the system.

In some examples, the methodologies described herein enable optimized execution by fusing multiple operations into a single operation. This approach minimizes the overhead associated with executing multiple discrete operations, leading to enhanced performance, particularly in computationally intensive tasks such as neural network inference.

In some examples, a compilation system in accordance with the methodologies described herein is designed to be flexible and extensible, allowing user-supplied kernels to be treated as first-class objects during the compilation process. This feature facilitates the integration of custom operations and optimizations without compromising the system's ability to perform standard optimizations effectively.

In some examples, the compilation system optimizes performance across various hardware platforms by employing device-specific transformations and kernel fusions. The compilation system supports diverse data types and operations, which enhances the compilation system's utility across different deployment environments.

In some examples, an advanced kernel generation process is utilized, involving sophisticated parameterization and optimization techniques to determine the optimal configuration for each kernel. This provides for generated kernels that are highly optimized for performance.

In some examples, an Artificial Intelligence (AI) component is incorporated to enhance the optimization of the compilation process. This AI assistance helps in conducting more efficient searches for optimal kernel configurations, leading to better optimization outcomes compared to traditional methods.

In some examples, the system collects and utilizes execution metrics to refine the compilation and execution processes continually. This adaptive approach ensures that the system learns from real-world applications to provide the best possible performance.

In some examples, a compilation system in accordance with this disclosure creates generic kernel generators with prologue functions for loading input data and epilogue functions for writing data to outputs with generic user-provided functions.

In some examples, a compilation system in accordance with this disclosure creates generic kernel generators with prologue functions for loading input data and epilogue functions for writing data to outputs with generic user-provided functions.

In some examples, a compilation system receives a multi-layered computational graph comprising a modular operation graph, wherein the modular generation graph comprises a set of modular operations. The compilation system generates a modular operation generator graph using the modular operation graph and one or more sets of kernels. The compilation system generates an optimized modular operation generator graph by performing one or more fusions of two or more operations of the modular operation generator graph and generates an executable object using the optimized modular operation generator graph.

In some examples, the compilation system selects kernels from a set of system kernels and a set of user supplied kernels using definitions of the set of modular operations of the modular operation graph.

In some examples, a kernel of the set of user supplied kernels is treated as a first class object during a compilation process.

In some examples, the compilation system selects the kernels using metadata of the set of user supplied kernels.

In some examples, an operation of the modular operation generator graph comprises one or more prologue functions defining a loading of input data into the operation.

In some examples, an operation of the modular operation generator graph comprises one or more epilogue functions defining a writing of output data of the operation.

Other technical features may be readily apparent to one skilled in the art from the following figures, descriptions, and claims.

### Compilation System

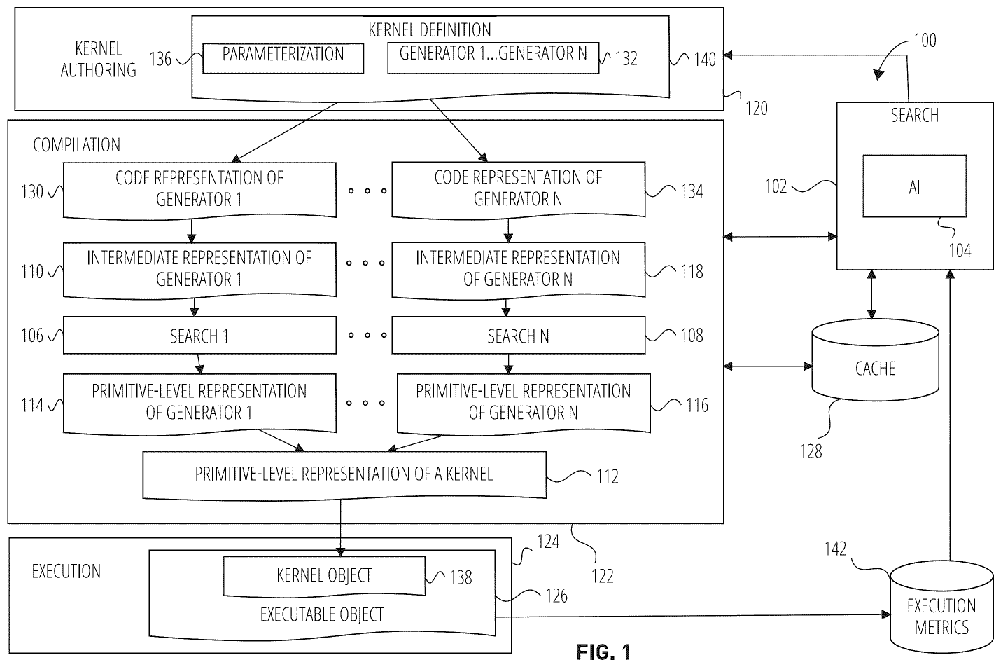

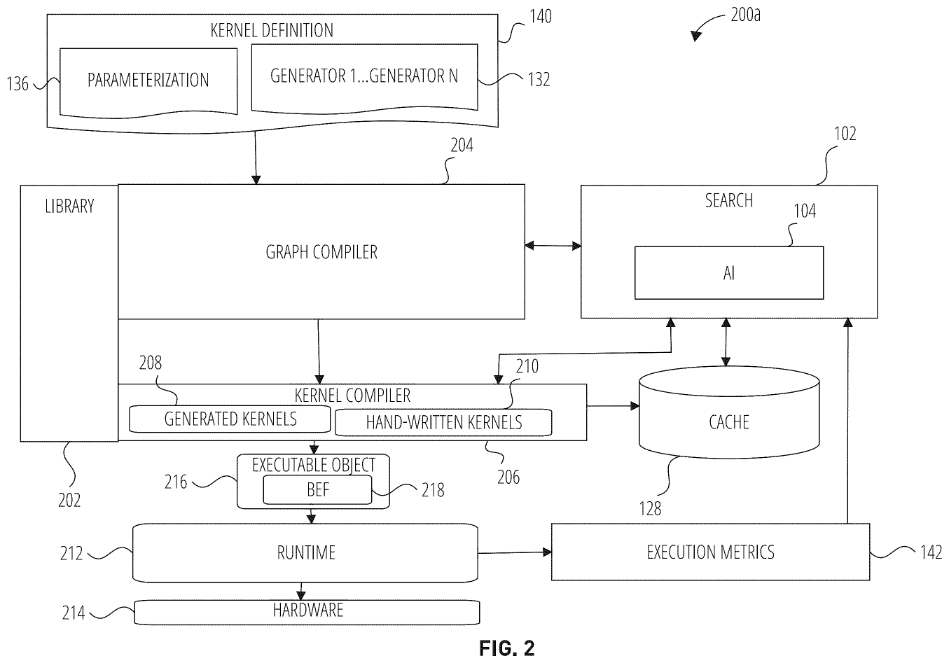

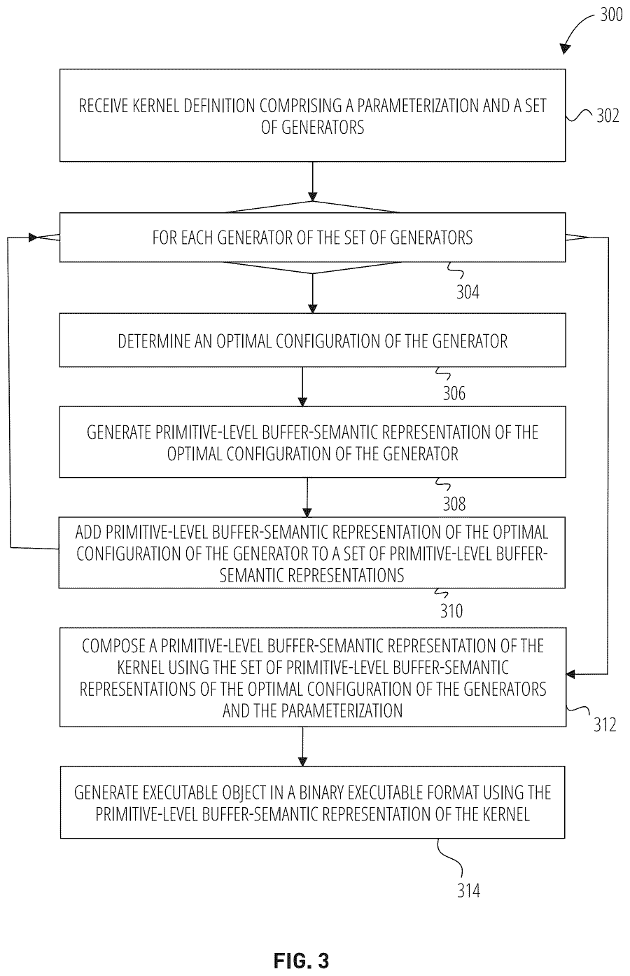

FIG. 1 is a data flow diagram of a compilation and execution process 100, in accordance with some examples. A user authors a kernel definition 140 during an authoring phase 120. The kernel definition 140 is used to compose a primitive-level representation of a kernel 112 in a compilation phase 122 as more fully described in reference to FIG. 3, by a compilation system 200a as more fully described in reference to FIG. 2.

The kernel definition 140 is comprised of a parameterization 136 and one or more generators 132. The generators 132 comprise coding logic, as illustrated by code representation of generator 1 130 and code representation of generator N 134, defining one or more operations to be performed by a kernel in accordance with the kernel definition 140. The operations may be organized into coding logic components such as, but not limited to operations, operators, functions, objects, routines, subroutines, modules, and the like, that operate on one or more data buffers. In some examples, the one or more generators 132 comprise definitions of one or more data structures comprising the data buffers.

The parameterization 136 comprises a set of parameters that guide how a compiler, such as graph compiler 204 or kernel compiler 206 (of FIG. 2), compiling the kernel definition 140 generates a primitive-level representation of a kernel 112 using the generators 132. In some examples, a generator 132 is written in a general purpose programming language such as Python or the like. In some examples, the parameterization 136 is a set of kernel parameters. In some examples, the parameterization 136 is comprised of a parsable scripting language or the like that generates the kernel parameters.

During the compilation phase 122, code of a generator 132, such as code representation of generator 1 130 and code representation of generator N 134, is lowered from the general purpose programming language into a lower level representation of the generator, such as primitive-level representation of generator 1 114 and primitive-level representation of generator N 116, through a series of intermediate representations, as illustrated by intermediate representation of generator 1 110 and intermediate representation of generator N 118. During the compilation phase 122, optimal configurations of the generators 132 are determined in a search, such as search 1 106 and search N 108, using the parameterization 136 and the intermediate representations of the generators 132 in a process more fully described in reference to FIG. 3. Search results and other compilation metrics are stored in a cache 128 for use during a subsequent search. A search may comprise searching through a tree of possible configurations using a combination of static analysis of prior configurations and a dynamic analysis of proposed configurations performed during an elaboration process as more fully described in reference to FIG. 3.

The primitive-level buffer-semantic representations of the generators 132 are combined into a primitive-level representation of a kernel 112. The primitive-level representation of a kernel 112 is stored for later use.

To generate an executable object, a kernel object 138 is generated using the primitive-level representation of a kernel 112 and the kernel object 138 is included in an executable object 126. Once generated, the executable object 126 is executed during the execution phase 124 and uses the kernel object 138 to perform one or more computations. In some examples, a library 202 is used to augment the kernel object 138 with additional executable objects.

In some examples, execution metrics of the kernels are stored in a datastore of execution metrics 142. The execution metrics 142 are used by a subsequent search component 102 to determine an optimal configuration of the one or more generators 132.

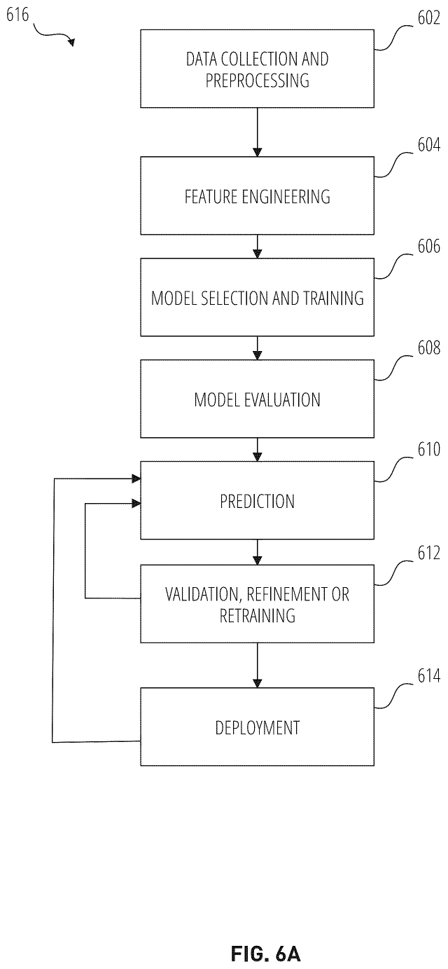

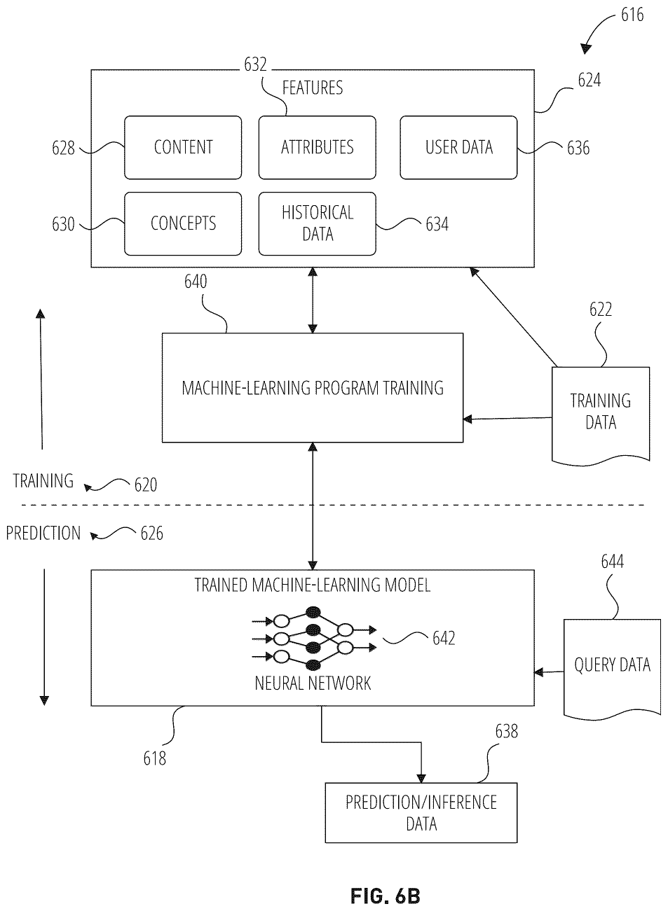

In some examples, an Artificial Intelligence (AI) component 104 is used to assist in a search. In some examples, the AI component 104 also assists during an authoring phase 120 during which kernels are written within a Software Development Environment (SDE) of an Integrated Development Environment (IDE). The training of the AI component 104 is more fully described in reference to FIG. 6A and FIG. 6B.

In some examples, one or more operations are defined by the generators 132 as a fusion of several other lower level operations, e.g., broadcast, activation operations, and sometimes even larger fused amalgams like Long Short-Term Memory (LSTM) operations. Describing generators at this level of abstraction simplifies high-level optimizations such as, but not limited to, extraction of shape operators, generation of operator gradients, and the like.

In some examples, the one or more generators 132 are used to generate implementations of existing functions or operators in existing Machine Learning (ML) frameworks (TFLite, TF, ONNX, PyTorch, and the like.). Operators in existing ML frameworks have attributes such as, but not limited to, broadcasting and type promotion support, handwritten operators chosen by experts that are known to be important to certain classes of models, e.g., activation operators fused into element wise generators like “add”, support for quantized algorithms that depend on architecture-specific DSP operations, layouts assumed by existing frameworks, support for dynamic shapes and dynamic dtypes, and the like.

In some examples, generators support:
Dynamic shapes
Broadcasting, type promotion: for example, “mul” is a binary generator, and the two operands can have different shapes and dtypes. ML frameworks often improve usability by providing implicit promotion to a common element type, and support broadcasting of elements.
Layout munging: some frameworks support multiple different layouts, e.g., row-major and col-major, tiled layouts, and the like. When the inputs are in different formats, a conversion may be needed. Some libraries use strides to provide a common implementation that can work with many different layouts, but strides are not general to tiled layouts.
Type dispatch: standard kernel libraries work on multiple dtypes, which are only known dynamically at kernel invocation time. This requires the kernel to dynamically dispatch over the dtype and dispatch to kernels specialized for many different dtypes. Some dtypes may have special cases, e.g., “complex add” can be handled by the same code path as “scalar add” (since complex addition is element wise), but “complex mul” is a completely different algorithm than “scalar mul”.
Thread Tiling: At the outer level of the type-specific kernel algorithm, the computation is carved into blocks that can be executed in parallel by multiple threads. The size of each subunit needs to be determined, and is generally best evaluated based on hardware characteristics and size of input data (not based on #available threads).
Cache Tiling: Within the per-thread computation, the computation is typically cache blocked, e.g., at the L2 level. The size of the L2 is target specific. It may be important for algorithms that make multiple passes over the data, and less important for element-wise operations that have little reuse.
Per Tile Algorithms: Within the per-L2 tiles, there are many ways to implement the core algorithm, including with scalars, vectors, using prefetches, and the like. There are also special cases that are interesting to handle when broadcasting is handled internally to the kernel, e.g., when the fastest varying dimension of one operand is broadcasted.
Many microkernels: Algorithms like matrix multiplication depend on lower-level operations like memset to clear buffers, panel dot products, reductions, and the like. These “microkernels” are themselves implementable in many different ways.
Macro algorithms: Many generators have multiple completely different algorithms for computing the result, e.g., in convolution we see the im2col approach, direct convolution, Winograd. Matmul has many implementations (particularly when quantization and accelerators force weird data layouts), also including Strassen's algorithm, and the like.
Hardware targets now frequently have spatial operations (like Apple AMX or Intel AMX) that can speed up multiple loop nests at a time, e.g., for matrix multiplication and large element wise blocks. They also have many architectural families that will want things register-blocked, pipelined, and unrolled differently.

In some examples, the primitive-level representation of a kernel 112 is a component of a framework comprised of a set of code generated kernels that operate on memory buffers such as, but not limited to, memory operators, 1D memory arrays, tensor buffers, user defined data structures, and the like. In some examples, kernels directly use C/C++, assembly, and intrinsics for specific hardware features.

In some examples, a library of kernel components is utilized to generate additional kernels. For example, buffer-level operators are utilized that replace legacy kernels. The kernel components are modular and reusable, including core algorithms such as, but not limited to, memory fills, reductions, element wise operators, and the like. in addition to more specialized primitives used in quantized kernels and other domains.

In some examples, generators are parametric generators. It is difficult for humans to create and maintain all permutations of a kernel by hand (e.g., for all dtypes, all target machines and the like.), so they pervasively turn to meta programming. This meta programming comes in a variety of forms, for example C macros and ifdefs, Python generator frameworks, “emitters” written in C++ against “IRBuilder” compiler APIs, but the most widely used are C++ templates.

In some examples, kernels are defined as declarative generators that take kernel parameters and have arbitrary imperative logic coded against them that is “burned into” the generated code for a kernel. This can be used to specialize on things like the dtype, unroll factors, vector lengths, cache sizes, and the like. Most parameters have integer type and are bounded by range (e.g., unroll<=8 times), a list of valid values (e.g., vector length=2, 4, 8, 16, 32), and should support enums (e.g., consider dtype), which makes them searchable. Using generators still permits use of concrete kernels (e.g., a fixed blob of assembly) since they are a valid generator with no parameters (or, equally, fully constrained parameters).

Example code is illustrated below. A kernel may have parameters bound at its invocation site, e.g., after a dynamic switch on dtype, the next-level down microkernel is invoked with a dtype parameter bound to a constant value:

```
// This fills a 1D buffer with unknown length but
known dtype with ones.
kgen.generator.interface
@fillWithOnesFixedDType<type: dtype>(%dest: !meta
.buffer<?xtype>)
// Fills a 1D buffer with unknown length and
unknown dtype with ones.
kgen.generator @fillWithOnes(%dest: !meta.buffer<
?x?>) {
  %dtype
= meta.buffer.dtype %dest : !meta.buffer<?x?>
  scf.switch %dtype { // dynamic switch
  case f32:
    %dstCast = meta.buffer.cast %dest
: !meta.buffer<?x?> to buffer<?xf32>
kgen.call @fillWithOnesFixedDType<type: dtype = f
32>(%dstCast)
  case i32:
    %dstCast = meta.buffer.cast %dest
: !meta.buffer<?x?> to buffer<?xi32>
kgen.call @fillWithOnesFixedDType<type: dtype = i
32>(%dstCast)
  case i8:
    %dstCast
= meta.buffer.cast %dest : !meta.buffer<?x?> to b
uffer<?xi8>
kgen.call @fillWithOnesFixedDType<type: dtype = i
8>(%dstCast)
  // ..
  }
}
```

FIG. 2 is a block diagram of a compilation system 200a, in accordance with some examples. A compilation system 200a generates software objects, such as kernels, using a kernel definition 140. The kernel definition 140 comprises a parameterization 136 and one or more generators 132. The compilation system 200a uses generated kernels 208 and hand-written kernels 210 to generate executable objects 216 in a binary executable format (BEF) BEF 218 using the generated kernels 208 and the hand-written kernels 210. The compilation system 200a uses a kernel generation method 300 to generate a kernel using the kernel definition 140.

In some examples, an executable object 216 in a binary executable format 218 including one or more kernel objects 138 executes during a runtime 212 on a set of hardware 214 devices and generates execution metrics 142 that are used to optimize generator configurations in order to optimize kernels.

Although various examples of the operation the compilation system 200a reference the generation of operations, kernels, and models for computational processes for Artificial Intelligence (AI) applications, it is to be understood that the compilation system 200a and the methodologies and systems of this disclosure may be applied to the compilation and generation of programs in interpretable or executable formats for any type of computational process such as, but not limited to, database processes, real-time processes, networking processes, client-server processes, and the like.

FIG. 3 is an activity diagram of a kernel generation method, in accordance with some examples. A compilation system 200a uses a kernel generation method 300 to compile or generate a kernel. Although the kernel generation method 300 depict a particular sequence of operations, the sequence may be altered without departing from the scope of the present disclosure. For example, some of the operations depicted may be performed in parallel, in a different sequence, or a different component of a composable kernel compilation system, such implementations do not materially affect the generator of the elaboration process. In other examples, different components of an example device or implementation of the compilation system 200a may perform operations at substantially the same time or in a specific sequence.

In operation 302, the compilation system 200a receives a kernel definition 140 comprising a parameterization 136 and one or more generators 132 that comprise coding logic that defines a kernel. In some examples, the code comprises generator code written in a general purpose programming language.

In operations 304 and 306, the compilation system 200a, for each generator, determines an optimal configuration of the generator using the parameterization 136. For example, the compilation system 200a searches for an optimal configuration of a generator using an evaluator associated with the generator. The kernel compiler 206 is capable of performing a static analysis search and a dynamic analysis search for an optimal configuration of a generator. In a static analysis search, the kernel compiler 206 uses a search component 102 to search through several different types of datastores. One type of datastore is a cache 128 containing optimal configurations of generators that can be reused by the kernel compiler 206 to determine an optimal configuration of a generator when lowering a generator during a compilation process. The cache 128 can be a local cache or a distributed cache distributed across remote storage nodes on one or more servers. For example, the compilation system 200a maintains a datastore of optimal configurations in the cache 128. The search component 102 looks for an optimal configuration for the generator using the evaluator which is a metric by which the search component 102 decides that a configuration of the generator is optimal.

In response to determining that an optimal configuration of the generator was not found during the static analysis search, the kernel compiler 206 performs a search using a dynamic analysis of the generator. To do so, the kernel compiler 206, generates a set of configurations. For example, the compilation system 200a generates an intermediate representation of the generator. The compilation system 200a uses the intermediate representation of the generator and the parameterization 136 to generate one or more configurations of the generator as one or more test intermediate representations of the generator.

The compilation system 200a generates a set of executable test functions using the one or more test intermediate representations. For example, for each test intermediate representation, the compilation system 200a lowers the test intermediate representation into an executable object in a BEF to generate the executable test function.

The compilation system 200a executes the set of test functions to determine a set of respective performance scores. For example, the composable kernel compilation system executes each test function and monitors the test function's performance as the test function operates on a test suite of data. In some examples, the performance score comprises an initialization score indicating an amount of time used by the test function during an initialization of the test function. In some examples, a performance score comprises an execution score indicating an amount of time that the test function takes to operate on the test data set. In some examples, the performance score includes an amount of time that a test function communicates with other generators of a kernel during execution.

The compilation system 200a selects an optimal configuration of the set of configurations using the set of respective performance scores. For example, the kernel compiler 206 assigns a weight to each set of generator, configuration, and performance data. During selection, the compilation system 200a selects a configuration of a generator using the sets of function, configuration, and performance evaluation data and their associated weights.

The compilation system 200a generates an intermediate representation of the generator using the optimal configuration and caches the optimal configuration of the generator in cache for later search processes.

In operation 308, the compilation system 200a generates a primitive-level buffer-semantic representation of the generator using the optimal configuration of the generator. For example, the compilation system 200a lowers the generator to the primitive-level buffer-semantic representation through successive compilation passes using one or more intermediate representations.

In operation 310, the compilation system 200a adds the primitive-level buffer-semantic representation of the generator to a set of primitive-level buffer-semantic representations of the generators. The set of primitive-level buffer-semantic representations of the generators are used to compose primitive-level buffer-semantic representation of a kernel.

In operation 312, the compilation system 200a composes a primitive-level buffer-semantic representation of kernel corresponding to the input generator using the set of primitive-level buffer-semantic representations of the generators. For example, the compilation system 200a takes the set of primitive-level buffer-semantic representations of the generators and code slices the primitive-level buffer-semantic representations of the generators and their dependencies into a single module or kernel.

In operation 314, the compilation system 200a lowers the single module to one or more object (.o) files and stores the one or more object files of the kernel in a datastore such as, but not limited to, a CAS or the like, of generated kernels 208. In some examples, the object file has a format of an object file that a standard C-style toolchain would produce, and so works seamlessly with stacks that implement a C/C++ Foreign Generator Interface (FFI).

### Fusion

The compilation system 200a employs multiple types of fusions. Examples include, but are not limited to, element-wise fusion (that operates an element at a time), reduction fusion (that reduces a sequence of elements into a smaller sequence of elements), and matrix multiplication (matmul) fusion (that allows fusion into a matmul operation).

Element-wise operations operate on an element-per-element basis. For example, for a 1D tensor, they correspond to the following loop: for i in range (shape [0]):
output [i]=func (input [i])

Where “shape” is a shape of the input tensor and “func” is dependent on a definition of the operation (e.g., a Tanh element-wise operation has Tanh as its innermost function).

In some examples, a compilation system 200a defines the element-wise generator as follows:

```
def elementwise[Rank: Int](
    shape: Index[Rank],
    function : Callable[Index[Rank]]
):
  parallel_for i in range(shape[:−1]):
      vectorize_for j in range(shape[0]):
        function(i+ [j])
```

Such a generator is parametrized on the rank for performance considerations and takes both a shape of the element-wise operation as well a function that is invoked for each index. It then parallelizes on the outermost dimensions and vectorizes on the innermost one. In some examples, the compilation system 200a allows a kernel author to specify these optimization patterns and provide their own functions.

Element-wise layers operate on each element of an input tensor.

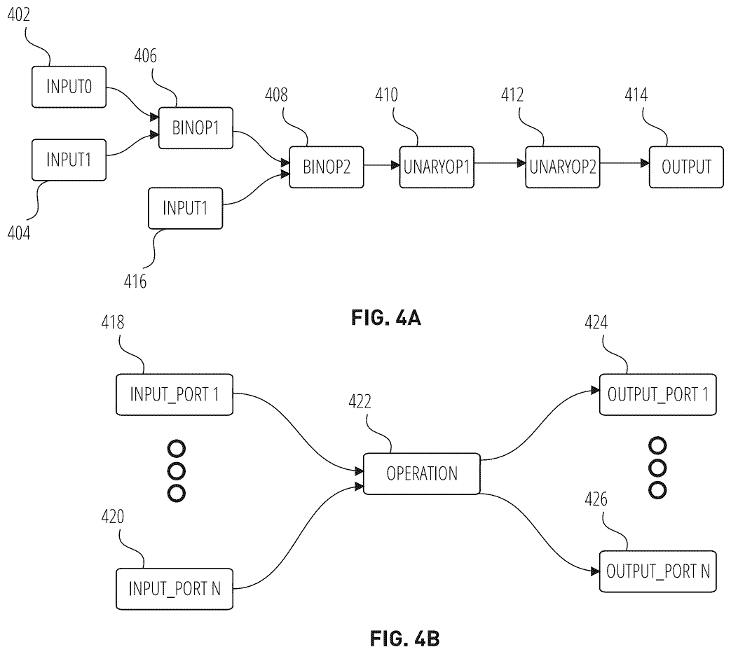

FIG. 4A illustrates an example element-wise sequence commonly found in generative models. A first binary operator, binop1 406, receives as input two inputs, input0 402 and input1 404. A second binary operator, binop2 408, receives as input the output of binop1 406 and another input, input1 416. A first unary operator unaryop1 410 receives as input the output of binop2 408. A second unary operator unaryop2 412 receives as input the output of unaryop1 410 and generates an output 414.

Each of these layers operates on each element of the input tensor-transforming it in the process. The graph of FIG. 4A can be expressed using the generator above by the following:

```
elementwise[rank_of(A)](
  lambda idx: unaryop2(unaryop1(
      binop2(
        binop1(input0[idx], input1[idx]),
        input2[idx])
      )
    )
)
```

In some examples, each of the above operation might take a broadcasted value. Broadcasting allows the performance of element-wise operations on two tensors with mismatching rank or dimensions. There are two types of broadcasting: explicit and implicit. In explicit broadcasting one materializes the broadcasted value. For example, during computation of A+B where shape (A)=d_0 \times d_1 and shape (B)=1\times 1 (i.e., a scalar) then a new matrix is created, matrix B′=d_0 \times d_1, which contains the B value. All computations that use A+B would be substituted with A+B′. The alternative is to perform the implicit broadcasting. Which means that the operator contains logic to handle the case where the B matrix can be broadcasted onto A. This makes the kernel writing potentially harder, but does not sacrifice speed. For example:
>{1,2,3}+5=⇒{1,2,3}+{5,5,5}=⇒{6,7,8}

In general implicit broadcasting is preferred over explicit broadcasting since it removes the need to materialize large tensors, improves locality, and reduces memory pressure.

Note that broadcasted fusion follows from the above. For example, in a case an ND tensor A which is added to a scalar B, then traditional frameworks will evaluate this by broadcasting B onto the dimensions of A (creating a temporary tensor), as exemplified by the following:
B_broadcast=broadcast (B, shape=shape of (A)) result=op (A, B_broadcast)

However, in a system in accordance with the disclosure, the following expression can be used
elementwise [rank of (A)] (lambda idx: op (A [idx], B))

In some examples, a user may define a matmul having insertion points for leveraging an internal matmul algorithm as illustrated in the following example of a generic naive-matmul algorithm:

A system in accordance with the disclosure provides for element wise epilogues and element-wise prologues. Without a prologue, certain optimizations cannot be expressed such as, but not limited to, quantization fusion within a matmul function.

```
□def generalized_matmul[InputType,OutputType](
    load_a_prologue: Callable[[int, int],
InputType],
    load_b_prologue: Callable[[int, int],
InputType],
    load_c_prologue: Callable[[int, int],
InputType],
    elem_wise_epilogue: Callable[[int, int,
OutputType], OutputType],
    row_wise_epilogue : Callable[[int,
List[OutputType]],void]
):
  for in range(M):
      row = [cast(0, OutputType)] * j
        for jin range(N):
          sum = cast(load_c_prologue(i,j),
OutputType)
          for k in range(K):
            sum+= load_a_prologue(i,k) *
load_b_prologue(k, j)
          row[j]= elem_wise_epilogue(sum)
        row_wise_epilogue(j, row)
```

The code above takes 5 functions as input:
load_a_prologue: defines how to load an A element given a row/col index. The function returns an element of type InputType.
load_b_prologue: defines how to load an B element given a row/col index. The function returns an element of type InputType.
load_c_prologue: defines how to load an C element given a row/col index. The function returns an element of type InputType.
elem_wise_epilogue: defines how to process a single compute element. The function passes in the row/col index along with the computed value of type OutputType.
row_wise_epilogue: defines how to process a single compute row. The function passes in the row index along with the computed row values of type OutputType. The function is responsible for storing the values of the row into the output buffer.

Using the above, a specialized version of the algorithm may be created. A traditional matmul may have the following signature:
def matmul (Output, A, B, transposeA=false, transposeB=false)

It computes either $A.B, A.B\hat{ }T, A\hat{ }T.B, A\hat{ }T.B\hat{ }T$ depending on the transposeA and transposeB flags. A system in accordance with the disclosure provides for a definition of a matmul as exemplified below:

```
def matmul[InputType,OutputType](Output, A,B,
transposeA,transposeB):
  load_a_prologue= lambda row,col: A[col,row]if
transposeA
        else lambda row,col:
A[row,col]
  load_b_prologue= lambda row,col: B[col,row]if
transposeB
        else lambda row,col:
B[row,col]
  load_c_prologue= lambda row,col: 0
  elem_wise_epilogue= lambda row,col,val: val
  row_wise_epilogue= lambda row,vals:
Output[row]=vals
  generalized_matmul[InputType,OutputType](
    load_a_prologue,
    load_b_prologue,
    load_c_prologue,
    elem_wise_epilogue,
    row_wise_epilogue
  )
```

One of the limitations of traditional GEneral Matrix Multiplication (GEMM) implementations is the inability to express $A.B+bias$ where $bias$ is a vector. This is not a limitation of the generalized matmul described herein. In an example, loading of the $C$ matrix from above is modified and a value of $bias$ is broadcast into $C$ as exemplified below:

```
def matmul_bias_1[InputType,OutputType](Output,
A,B, bias):
  load_a_prologue= lambda row,col:
A[row,col]  load_b_prologue= lambda row,col:
B[row,col]
  load_c_prologue= lambda row,col: bias[row]
  elem_wise_epilogue= lambda row,col,val: val
  row_wise_epilogue= lambda row,vals:
Output[row]=vals
  generalized_matmul[InputType,OutputType](
    load_a_prologue,
    load_b_prologue,
    load_c_prologue,
    elem_wise_epilogue,
    row_wise_epilogue
  )
```

In an example, an element wise epilogue function is modified to accumulate a bias into a resulting value

```
def matmul_bias_1[InputType,OutputType](Output,
A,B, bias):
  load_a_prologue= lambda row,col: A[row,col]
  load_b_prologue= lambda row,col: B [row,col]
  load_c_prologue= lambda row,col: 0
  elem_wise_epilogue= lambda row,col,val: val+
bias[row]
  row_wise_epilogue= lambda row,vals:
Output[row]=vals
  generalized_matmul[InputType,OutputType](
    load_a_prologue,
    load_b_prologue,
    load_c_prologue,
    elem_wise_epilogue,
    row_wise_epilogue
  )
```

Both of the examples above are equivalent, but theoretically the second implementation should be faster since it avoids a memcpy.

Building upon the matmul+bias operation, we can define a Fully Connected (PC) layer. The PC layer performs a function of Sactivation (A.B+bias) $ as exemplified below:

```
def fc[InputType,OutputType](Output, A,B, bias,
activation):
  load_a_prologue= lambda row,col: A[row,col]
  load_b_prologue= lambda row,col: B[row,col]
  load_c_prologue= lambda row,col: 0
  elem_wise_epilogue= lambda row,col,val:
activation(val+ bias[row])
  row_wise_epilogue= lambda row,vals:
Output[row]=vals
  generalized_matmul[InputType,OutputType](
    load_a_prologue,
    load_b_prologue,
    load_c_prologue,
    elem_wise_epilogue,
    row_wise_epilogue
  )
```

In some examples, fusion patterns can be fused together as well. For example, elementwise, reduction, and matmul fusion patterns may be fused together to generate the single head attention block.

A single head attention equation (also called scaled dot product) is shown below:

$$Attention ( Q , K , V ) = Softmax ( \frac{{QK}^{T}}{\sqrt{{d}_{k}}} ) V$$

Where:
Q=a query vector that represents a current word or token that is being processed by the attention mechanism;
K=a key vector that represents the other words or tokens in the input sequence that could potentially be relevant to the current word or token;
V=a value vector that represents the values associated with the key vector, such as the word embeddings for the corresponding words or tokens;
T=a dimensionality of the input vectors, including the query vector “Q”, the key vector “K”, and the value vector “V”; and
dₖ=a dimensionality of the attention weights.

A softmax function can be defined by:

```
def SoftmaxUnbatched(Output,Input):
  maxVal = −∞
  denom = 0
  for i in range(N):
    maxVal = max(maxVal, Input[b,i])
  for i in range(N):
    Output[b,i] = exp(Input[b, i]− maxVal)
    denom += Output[b, i]
  for i in range(N):
    Output[b,i] /= denom
```

Note that a first step is an element-wise operation, whereas a second and third steps are row-wise. Accordingly, a fused attention block implementing the can be defined as:

```
def
scaled_dot_product[InputType,OutputType](Output,
Q,K, V):
  load_a_prologue= lambda row,col: Q[row,col]
  load_b_prologue= lambda row,col: K[col,row]
  load_c_prologue= lambda row,col: 0
  # initialize a buffer of max values for each
row
  max_values= [−inf] * len(A)
  def elem_wise_epilogue(row, col,val):
    max_values[row]=max(max_values[row],val)
    return val
  def row_wise_epilogue(row, vals):
      denom = 0
      for col, val in enumerate(vals):
        Output[row,col] = exp(val −
max_values[row])
        denom+= Output[row,col]
      for col in range(len(vals)):
        Output[row,col] /= denom
  generalized_matmul[InputType,OutputType](
    load_a_prologue,
    load_b_prologue,
    load_c_prologue,
    elem_wise_epilogue,
    row_wise_epilogue
  )
  matmul(Output,V, Output)
```

Fusion patterns are declaratively defined by the user with annotations to describe the type of fusion that is allowed. Those annotations communicate with the graph compiler to describe which types of fusions are allowed and how to integrate points where fusion is allowed. In reference to FIG. 4B, an operation 422 generated by a kernel generator comprises a set of input ports where the set of input ports is of arbitrary size, as illustrated by input_port 1 418 to input_port N 420, and a set of output ports where the set of output ports is of arbitrary size, as illustrated by output_port 1 424 to output_port N 426. When executing, the operation 422 receives inputs from the set of input ports and generates outputs output through the output ports. These ports are functions that can perform any arbitrary operation such as, but not limited to, loads/stores, computing activations, performing reductions, and the like.

The user communicates this information to a graph compiler by declaring these ports and capabilities. For example, for a generic matmul example above, a registration may be exemplified by:

```
@register(“matmul”)
@declare_input(input, position=0, type=“element-
wise”)
@declare_input(input, position=1, type=“element-
wise”)
@declare_input(input, position=2, type=“element-
wise”)
@declare_output(output, position=0,
type=“element-wise”)
@declare_output(output, position=0, type=“row-
wise”)
def generalized_matmul[InputType,OutputType](
  load_a_prologue: Callable[[int, int],
InputType],
  load_b_prologue: Callable[[int, int],
InputType],
  load_c_prologue: Callable[[int, int],
InputType],
  elem_wise_epilogue: Callable[[int, int,
OutputType], OutputType],
  row_wise_epilogue : Callable[[int,
List[OutputType]],void]
):
  ...
```

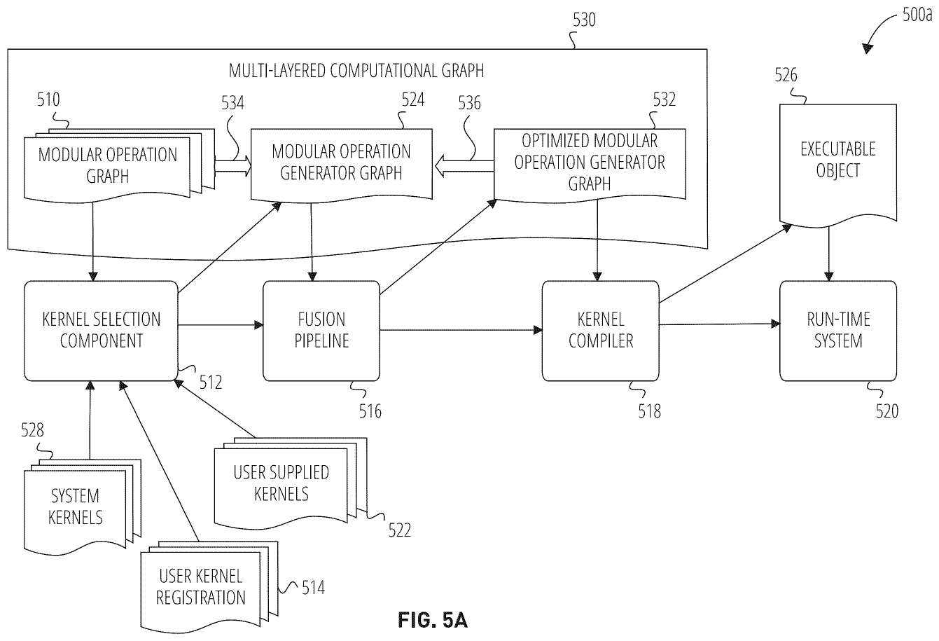

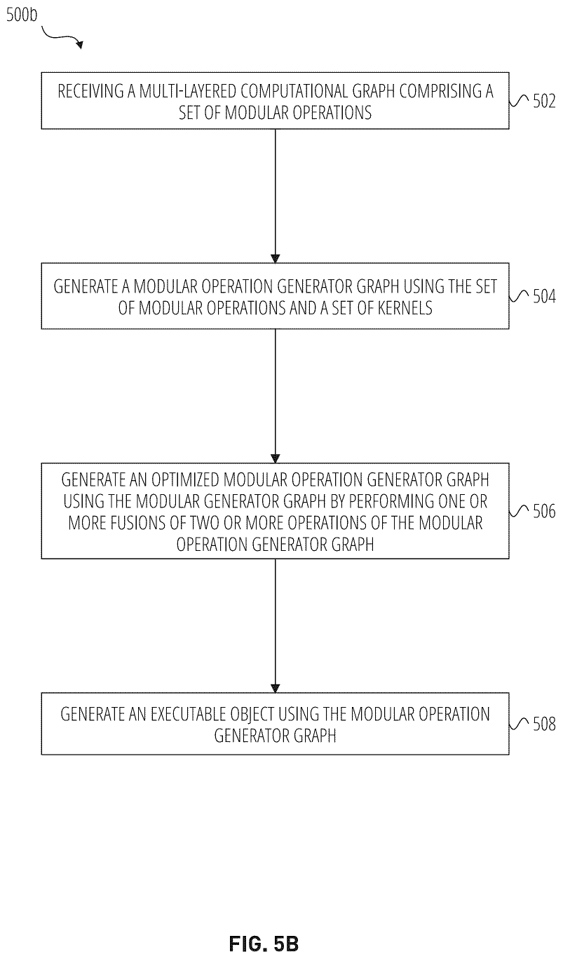

FIG. 5A is a collaboration diagram of a multi-layered graph compiler pipeline 500a and FIG. 5B is an activity diagram of a compilation method 500b using multi-layered computational graphs, in accordance with some examples. A compilation system 200a uses the multi-layered graph compiler pipeline 500a to generate executable objects, such as executable object 526, using a multi-layered computational graph 530 and sets of kernels, such as a set of system kernels 528 and a set of user supplied kernels 522.

In many ML systems, models are represented as a series of computational graphs. These graphs can be optimized to remove redundant computation, perform device specific transforms, and fuse kernels. A traditional graph optimizer uses a single layer of intermediate representation and conditions optimization based on what device or kernel library has been specified when the graph was initialized. Such a process leads to complexity in both the implementation of the optimization passes and extensions of a system that generates the models.

To alleviate some of the problems with computational graphs in other systems and provide better integration with the compilation system 200a, multi-layered computational graph 530 representation is employed.

In operation 502, a compilation system 200a receives a multi-layered computational graph 530 comprising a modular operation graph 510. For example, the modular operation graph 510 comprises one or more modular operations forming a Modular Operations (MO) layer. The modular operation graph 510 provides a type system, device independent rewrites, and a canonical operation set for doing rewrites.

In operation 504, the compilation system 200a generates a modular operation generator graph 524 using the modular operation graph 510 and one or more sets of kernels such as, but not limited to, a set of system kernels 528 and a set of user supplied kernels 522. At a Modular Operation Generator Graph (MOGG) layer of the multi-layered computational graph 530, operations of a modular operation generator graph 524 are kernel-aware. During transition 534 from s modular operation graph 510 to a modular operation generator graph 524, kernels are selected from a set of system kernels 528 and a set of user supplied kernels 522 by a kernel selection component 512 in a selection process. The selected kernels are selected based on the definitions of the set of modular operations of the modular operation graph 510. The kernel selection component 512 generates a set of MOGG operations for a modular operation generator graph 524 with properties that reflect how kernels selected from the set of user supplied kernels 522 are constructed. In some examples, a user supplies one or more user kernel registrations 514 comprising metadata of the set of user supplied kernels 522 that the kernel selection component 512 uses to select kernels from the set of user supplied kernels 522.

In some example, in a case of kernels written for the compilation system 200a, a MOGG operation of a modular operation generator graph 524 directly represents an underlying structure of a kernel generator the kernels are based on. For example, the generalized_matmul example above would turn into the following multi-layer intermediate representation (with types removed for brevity):

```
>>mogg.kernel(%A, %B, %C) [fusionType=matmul]{
  %1= mogg.output_placeholders
  mogg.lambda @load_a_prologue =(%index) −
>[fusionType=element-wise] {
  %2 = mogg.simd_load(%A,%index)
  mogg.output %2
  }
  mogg.lambda @load_b_prologue =(%index) −>
[fusionType=element-wise]{
  %2 = mogg.simd_load(%B,%index)
  mogg.output %2
  }
  mogg.lambda @load_c_prologue =(%index) −
>[fusionType=element-wise]{
  %2 = mogg.simd_load(%C,%index)
  mogg.output %2
  }
  mogg.lambda @elem_wise_epilogue =(%index,
%value)−> [fusionType=element-wise]{
  mogg.output %value
  }
  mogg.lambda @row_wise_epilogue =(%index,
%value)−> [fusionType=row-wise]{
  mogg.output %value
  }
  mogg.call “generic_matmul”
[@load_a_prologue,
```

@load_b_prologue

,

@load_c_prologue

,

@elem_wise_epil

ogue,

@row_wise_epilo

```
uge](%1)
  mogg.output %1 : !mo.tensor<[6], si32>
  } {inputFusionInterface =[“load_a_prologue”,
“load_c_prologue”, “load_c_prologue”],
  outputFusionInterface
=[“elem_wise_epilogue”, “row_wise_epilogue”]}
```

In the foregoing example, all of the operations are labeled with fusion types, and identity implementations of all prologue and epilogue functions are created. These processes are performed automatically via declaration and registration decorators added to the kernel when converting an ML model into binary format.

In operation 506, a fusion pipeline 516 of the compilation system 200a generates an optimized modular operation generator graph 532 using the modular operation generator graph 524 by performing one or more fusions of two or more operations of the modular operation generator graph 524. As a result, the optimized modular operation generator graph 532 will comprise one or more fused operations. For example, after generation of the modular operation generator graph 524 by the compilation system 200a, the fusion pipeline 516 has concrete knowledge of both the device targets and kernel definitions for every operation in a modular operation generator graph 524. The fusion pipeline 516 can thus perform device and kernel specific optimizations 536 on the computational modular operation generator graph 524.

In some examples, all kernels, and all prologue functions and all epilogue functions in a kernel, have fusion classifications such as, but not limited to, elementwise, row wise, reduction, opaque, and the like. The fusion pipeline 516 traverses the modular operation generator graph 524 and finds places where a body of a kernel matches an appropriate input lambda of another kernel. For kernels labeled elementwise, row wise, and reduction, those bodies can then be directly inlined into the appropriate input or output lambda of the other kernel. In some examples, kernels labeled opaque are not fused into other kernels, but they can accept the fusion of many other kernel into their own inputs and outputs.

In operation 508, a kernel compiler of the compilation system 200a generates an executable object using the optimized modular operation generator graph 532. For example, the generated lambda functions are inlined into the user's kernel definition by copying the definitions of the lambda functions into the kernel definition at the point where the lambda functions are invoked during compilation by a kernel compiler 518 and run as native novel kernels in a final executable object 526 executed by a run-time system 520.

In some examples, by implementing a multi-layered graph compiler pipeline 500a having a fusion pipeline 516 as described herein, a compilation system 200a provides for user extensibility of the compilation process. As the fusion pipeline 516 operates on the modular operation generator graph 524 after device specific kernel selection by the kernel selection component 512, interfaces are generated from kernel definitions and, because a user supplied kernel only needs to meet the Application Programming Interfaces (APIs) the fusion pipeline 516 expects, user provided kernels and operations can be treated as first class objects by the compilation system 200a during compilation and receive the same optimization treatment as other first class objects within the compilation system 200a.

### Machine-Learning Pipeline

FIG. 6B is a flowchart depicting a machine-learning pipeline 616, according to some examples. The machine-learning pipeline 616 may be used to generate a trained machine-learning model 618, for example a machine-learning model as used by AI component 104 of FIG. 1 to perform kernel searching and compiler optimization.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

### Training Phases

Generating a trained machine-learning model 618 may include multiple phases that form part of the machine-learning pipeline 616, including for example the following phases illustrated in FIG. 6A:
Data collection and preprocessing 602: This phase may include acquiring and cleaning data to ensure that it is suitable for use in the machine learning model. This phase may also include removing duplicates, handling missing values, and converting data into a suitable format.
Feature engineering 604: This phase may include selecting and transforming the training data 622 to create features that are useful for predicting the target variable. Feature engineering may include (1) receiving features 624 (e.g., as structured or labeled data in supervised learning) and/or (2) identifying features 624 (e.g., unstructured or unlabeled data for unsupervised learning) in training data 622.
Model selection and training 606: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 608: This phase may include evaluating the performance of a trained model (e.g., the trained machine-learning model 618) on a separate testing dataset. This phase can help determine if the model is overfitting or underfitting and determine whether the model is suitable for deployment.
Prediction 610: This phase involves using a trained model (e.g., trained machine-learning model 618) to generate predictions on new, unseen data.
Validation, refinement or retraining 612: This phase may include updating a model based on feedback generated from the prediction phase, such as new data or user feedback.
Deployment 614: This phase may include integrating the trained model (e.g., the trained machine-learning model 618) into a more extensive system or application, such as a web service, mobile app, or IoT device. This phase can involve setting up APIs, building a user interface, and ensuring that the model is scalable and can handle large volumes of data.

FIG. 6B illustrates further details of two example phases, namely a training phase 620 (e.g., part of the model selection and trainings 606) and a prediction phase 626 (part of prediction 610). Prior to the training phase 620, feature engineering 604 is used to identify features 624. This may include identifying informative, discriminating, and independent features for effectively operating the trained machine-learning model 618 in pattern recognition, classification, and regression. In some examples, the training data 622 includes labeled data, known for pre-identified features 624 and one or more outcomes. Each of the features 624 may be a variable or attribute, such as an individual measurable property of a process, article, system, or phenomenon represented by a data set (e.g., the training data 622). Features 624 may also be of different types, such as numeric features, strings, and graphs, and may include one or more of content 628, concepts 630, attributes 632, historical data 634, and/or user data 636, merely for example.

In training phase 620, the machine-learning pipeline 616 uses the training data 622 to find correlations among the features 624 that affect a predicted outcome or prediction/inference data 638.

With the training data 622 and the identified features 624, the trained machine-learning model 618 is trained during the training phase 620 during machine-learning program training 640. The machine-learning program training 640 appraises values of the features 624 as they correlate to the training data 622. The result of the training is the trained machine-learning model 618 (e.g., a trained or learned model).

Further, the training phase 620 may involve machine learning, in which the training data 622 is structured (e.g., labeled during preprocessing operations). The trained machine-learning model 618 implements a neural network 642 capable of performing, for example, classification and clustering operations. In other examples, the training phase 620 may involve deep learning, in which the training data 622 is unstructured, and the trained machine-learning model 618 implements a deep neural network 642 that can perform both feature extraction and classification/clustering operations.

In some examples, a neural network 642 may be generated during the training phase 620, and implemented within the trained machine-learning model 618. The neural network 642 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 642 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 642 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 620, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 626, the trained machine-learning model 618 uses the features 624 for analyzing query data 644 to generate inferences, outcomes, or predictions, as examples of a prediction/inference data 638. For example, during prediction phase 626, the trained machine-learning model 618 generates an output. Query data 644 is provided as an input to the trained machine-learning model 618, and the trained machine-learning model 618 generates the prediction/inference data 638 as output, responsive to receipt of the query data 644.

In some examples, the types of training data included in execution metrics 142 (of FIG. 2) that are collected by the compilation system 200a (of FIG. 2) during runtime 212 (of FIG. 2) to train a trained machine-learning model 618 of the AI component 104 include, but are not limited to:

Execution Metrics (Execution Phase Data):
Performance scores for different kernel configurations, including execution time and loading time.
Data on the efficiency of kernel execution on various hardware devices.
Metrics related to the computational resources consumed by kernels, such as CPU usage, memory usage, and I/O operations.

Kernel Generation Data (Compilation Phase Data):
Historical data on the success rates of different kernel configurations.
Information on the parameterization choices made during kernel generation and their outcomes.
Data on the frequency and context of use for various kernel parameters and configurations.

Kernel Authoring Data (Kernel Authoring Phase Data):
Patterns in code structure and syntax that lead to more efficient kernels.
Common errors or inefficiencies in kernel code that an AI component can learn to identify and correct.
User interactions with an SDE, such as the use of specific tools or features that aid in kernel authoring.

Search Data (Search Phase Data):
Results of searches for optimal configurations, including the paths taken through the search space and the effectiveness of different search strategies.
The impact of AI-assisted searches on the quality and performance of the resulting kernels.

Training and Prediction Data (Machine Learning Program Training Data):
Features extracted from kernels and their performance metrics that are relevant for training the AI model.
Historical data on kernel performance that can be used to train predictive models within the AI component.
Validation and refinement data from iterative training processes to improve the accuracy of the AI model.

User Data (Software Development Environment Data):
Feedback from developers on the suggestions provided by the AI component.
Usage patterns of the Software Development Environment that can inform the AI component's recommendations.

Deployment Data:
Information on how kernels perform in a production environment, which can be used to further refine the AI model.

By collecting and analyzing these types of execution data, the compilation system 200a can train the trained machine-learning model 618 used within an AI component 104 to better assist in the search and kernel authoring phases, ultimately leading to more efficient and effective kernel generation and deployment.

In some examples, the compilation system 200a collects kernel compilation data and generation data collected during a compilation phase and uses the collected compilation data and generation data to train the trained machine-learning model 618 used in the AI component 104 includes, but is not limited to:

Compilation Time Metrics:
Duration of the compilation process for each kernel or set of kernels.
Resources used during compilation, such as CPU and memory usage.

Intermediate Representation Data:
Characteristics of the intermediate representations generated during the lowering of high-level code to machine code.
Transformations applied to the code during the compilation stages and their effects on performance.

Configuration and Parameterization Data:
The specific parameter values chosen for kernel generation and their impact on the compiled kernel's performance.
Frequency and effectiveness of different parameter combinations used during kernel generation.

Optimization Outcomes:
Success rates of various optimization techniques applied during the compilation, such as loop unrolling, vectorization, and inlining.
Performance improvements achieved through specific optimizations.

Error and Warning Logs:
Compilation errors and warnings that occur, which can be used to identify common issues and improve the robustness of the compilation process.

Search Algorithm Data:
Paths taken through the search space when determining optimal configurations.
Effectiveness of different search strategies and heuristics used by the AI component.

Code Generation Patterns:
Common patterns or idioms in the generated code that correlate with higher performance or efficiency.
Variations in the generated assembly or machine code for different target architectures.

Feedback from Runtime Performance:
Data on how well the kernels perform once deployed, which can be used to adjust the compilation strategies retrospectively.

Developer Interaction Data:
Inputs and adjustments made by developers during the kernel authoring phase that influence the compilation outcomes.
Usage patterns of compilation flags and directives provided by developers.

By collecting and analyzing this kernel generation data, the AI component can learn to predict the most effective compilation strategies for different scenarios, leading to more efficient kernel generation and potentially reducing the time and resources required for the compilation phase. This data-driven approach can significantly enhance the capabilities of the AI component in assisting with kernel generation and optimization.

In some examples, the trained machine-learning model 618 may be a generative AI model. Generative AI is a term that may refer to any type of artificial intelligence that can create new content from training data 622. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the query data 644 may include text, audio, image, video, numeric, or media content prompts and the output prediction/inference data 638 includes text, images, video, audio, code, or synthetic data.

In some examples, the training phase 620 and the prediction phase 626 are performed on a distributed system such as compilation system 200a of FIG. 2.

In some examples, one or more of the operations of the training phase 620 and the prediction phase 626 are performed on a local device as part of a JIT compilation process.

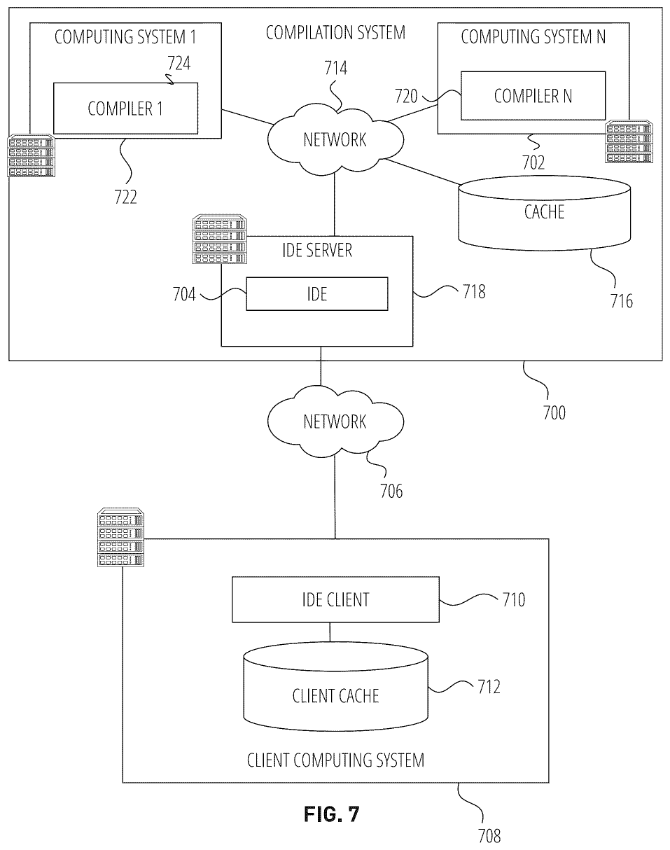

FIG. 7 is a collaboration diagram of a networked compilation system 700, in accordance with some examples. The compilation system 700 includes one or more computing systems, such as computing system 1 722 to computing system N 702 in communication via one or more networks, such as network 714. In some examples, the network 714 is a Local Area Network (LAN). In some examples, the network 714 is a Wide Area Network (WAN) such as the Internet or the like.

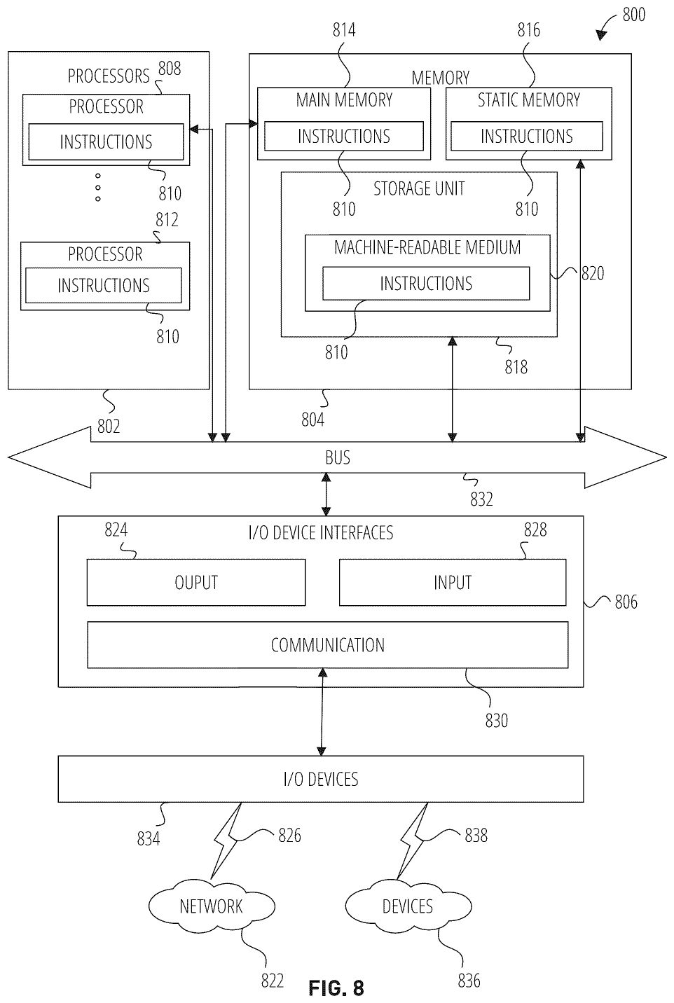

The computing systems comprise one or more computing machines, such as machine 800 of FIG. 8. The one or more computing systems hosts one or more compilers, such as computing system 1 722 hosting compiler 1 724 and computing system N 702 hosting compiler N 720. Each of the compilers are communicatively coupled, via one or more communication networks including a Local Areal Network (LAN) 714, to other compilers of the compilation system 700 (e.g., hosted on respective other computing systems,). A compiler can also communicate with locally hosted applications of their respective computing system using Application Program Interfaces (APIs).

The compilation system 700 further includes a cache 716 communicatively coupled to the compilers via one or more networks, such as the network 714.

The compilation system 700 further includes an Integrated Development Environment Server (IDE) 718 hosting an IDE 704. The IDE 704 is communicatively coupled to the compilers via one or more communication networks, such as the network 714.

A compiler interacts with other compilers and with the IDE 704 via the network 714. The data exchanged between the compilers and the IDE 704 includes functions (e.g., commands to invoke functions) and payload data (e.g., coding logic for compilation).

A client computing system 708 hosts an IDE client 710 that is communicatively coupled to the IDE 704 via one or more communication networks, such as network 706. In some examples, the network 706 is a LAN. In some examples, the network 706 is a WAN such as the Internet or the like.

A user uses the IDE client 710 to communicate with the IDE 704 and write the coding logic that is compiled by the compilers. During compilation, the compilers may access the cache 716 during compilation to store intermediate representations and/or executable objects of the coding logic. In some examples, the IDE client 710 is in communication with a client cache 712. The compilers may access the client cache 712 via the IDE client 710 during compilation to store intermediate representations and/or executable objects of the coding logic.

The compilation system 700 provides server-side compiling functionality as described herein via the Network 706 to the IDE client 710. While certain functions of the compilation system 700 are described herein as being performed by a compiler, such as compiler 1 724 and compiler N 720, the IDE 704, or one or more client-side API or applications, the location of certain functionality within the compilation system 700 or the client computing system 708 may be a design choice. For example, it may be technically preferable to initially deploy particular technology and functionality within the client computing system 708 but to later migrate this technology and functionality to the compilation system 700 where a computing system of the compilation system 700, such as computing system N 702, has sufficient processing capacity.

The compilation system 700 supports various services and operations that are provided to the client computing system 708. Such operations include transmitting data to, receiving data from, and processing data generated by the compilation system 700 and the client computing system 708. This data may include, but is not limited to, coding logic, intermediate representations and/or executable objects of coding logic, compilation metrics, execution metrics of one or more executable objects, and the like. The IDE 704 provides, via the IDE client 710, one or more User Interfaces (UI) that a user uses to access the functionality of the compilation system 700.

In some examples, the IDE 704, the cache 716, and one or more compilers, such as compiler 1 724 and compiler N 720, are hosted by a single computing system. In some examples, the IDE 704, the cache 716, and one or more compilers, such as compiler 1 724 and compiler N 720, are hosted in a cloud-based computing environment.

FIG. 8 is a diagrammatic representation of a machine 800 within which instructions 810 (e.g., software, a program, an application, an applet, an app, or other executable code) for causing the machine 800 to perform any one or more of the methodologies discussed herein may be executed. For example, the instructions 810 may cause the machine 800 to execute any one or more of the methods or processes described herein. The instructions 810 transform the general, non-programmed machine 800 into a particular machine 800 programmed to carry out the described and illustrated generators in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 in conjunction with other components of a compiler system may generator as, but not limited to, a server, a client, computer, a personal computer (PC), a tablet computer, a laptop computer, or any machine capable of executing the instructions 810, sequentially or otherwise, that specify actions to be taken by the machine 800. Further, while a single machine 800 is illustrated, the term “machine” may also be taken to include a collection of machines that individually or jointly execute the instructions 810 to perform any one or more of the methodologies discussed herein.

The machine 800 may include one or more processors 802, memory 804, and I/O device interfaces 806, which may be configured to communicate with one another via a bus 832. In an example, the processors 802 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 808 and a processor 812 that execute the instructions 810. The term “processor” is intended to include multi-core processors that may comprise two or more independent processors (sometimes referred to as “cores”) that may execute instructions contemporaneously. Although FIG. 8 shows multiple processors 802, the machine 800 may include a single processor with a single core, a single processor with multiple cores (e.g., a multi-core processor), multiple processors with a single core, multiple processors with multiples cores, or any combination thereof.

The memory 804 includes a main memory 814, a static memory 816, and a storage unit 818, both accessible to the processors 802 via the bus 832. The main memory 804, the static memory 816, and storage unit 818 store the instructions 810 embodying any one or more of the methodologies or generators described herein. The instructions 810 may also reside, completely or partially, within the main memory 814, within the static memory 816, within a non-transitory machine-readable medium 820 within the storage unit 818, within one or more of the processors 802 (e.g., within the processor's cache memory), or any suitable combination thereof, during execution thereof by the machine 800.

The I/O device interfaces 806 couple the machine 800 to I/O devices 834. One or more of the I/O devices 834 may be a component of machine 800 or may be separate devices. The I/O device interfaces 806 may include a wide variety of interfaces to the I/O devices 834 used by the machine 800 to receive input, provide output, produce output, transmit information, exchange information, capture measurements, and so on. The specific I/O device interfaces 806 that are included in a particular machine will depend on the type of machine. It will be appreciated that the I/O device interfaces 806 the I/O devices 834 may include many other components that are not shown in FIG. 8. In various examples, the I/O device interfaces 806 may include output component interfaces 824 and input component interfaces 828. The output component interfaces 824 may include interfaces to visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input component interfaces 828 may include interfaces to alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O device interfaces 806 further include communication component interfaces 830 operable to couple the machine 800 to a network 822 or one or more devices 836 via coupling 826 and a coupling 838, respectively. For example, the communication component interfaces 830 may include an interface to a network interface component or another suitable device to interface with the network 822. In further examples, the communication component interfaces 830 may include interfaces to wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 836 may be another machine or any of a wide variety of peripheral devices (e.g., a peripheral device coupled via a USB).

The various memories (e.g., memory 804, main memory 814, static memory 816, and/or memory of the processors 802) and/or storage unit 818 may store one or more sets of instructions and data structures (e.g., software) embodying or used by any one or more of the methodologies or generators described herein. These instructions (e.g., the instructions 810), when executed by processors 802, cause various operations to implement the disclosed examples.

The instructions 810 may be transmitted or received over the network 822, using a transmission medium, via a network interface device (e.g., a network interface component included in the communication component interfaces 830) and using any one of a number of well-known transfer protocols (e.g., hypertext transfer protocol (HTTP)). Similarly, the instructions 810 may be transmitted or received using a transmission medium via the coupling 838 (e.g., a peer-to-peer coupling) to the devices 836.

To better illustrate the system and methods described herein, a non-limiting list of examples is provided here:

Example 1 is a computer-implemented method comprising: receiving a multi-layered computational graph comprising a modular operation graph, the modular generation graph comprising a set of modular operations; generating a modular operation generator graph using the modular operation graph and one or more sets of kernels; generating an optimized modular operation generator graph by performing one or more fusions of two or more operations of the modular operation generator graph; and generating an executable object using the optimized modular operation generator graph.

In Example 2, the subject matter of Example 1 includes, wherein generating a modular operation generator graph comprises: selecting kernels from a set of system kernels and a set of user supplied kernels using definitions of the set of modular operations of the modular operation graph.

In Example 3, the subject matter of any of Examples 1-2 includes, wherein a kernel of the set of user supplied kernels is treated as a first class object during a compilation process.

In Example 4, the subject matter of any of Examples 2-3 includes, wherein selecting the kernels further uses metadata of the set of user supplied kernels.

In Example 5, the subject matter of any of Examples 1˜4 includes, wherein an operation of the modular operation generator graph comprises one or more prologue functions defining a loading of input data into the operation.

In Example 6, the subject matter of any of Examples 1-5 includes, wherein an operation of the modular operation generator graph comprises one or more epilogue functions defining a writing of output data of the operation.

Example 7 is at least one machine-readable medium including instructions that, when executed by processing circuitry, cause the processing circuitry to perform operations to implement of any of Examples 1-6.

Example 8 is an apparatus comprising means to implement of any of Examples 1-6.

Example 9 is a system to implement of any of Examples 1-6.

Example 10 is a method to implement of any of Examples 1-6.

Changes and modifications may be made to the disclosed examples without departing from the scope of the present disclosure. These and other changes or modifications are intended to be included within the scope of the present disclosure, as expressed in the following claims.

### Glossary

A “carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

A “client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

A “communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

A “machine-readable medium” refers to both machine-storage media and transmission media. Thus, the terms include both storage devices/media and carrier waves/modulated data signals. The terms “machine-readable medium,” “machine-readable medium” and “device-readable medium” mean the same thing and may be used interchangeably in this disclosure.

A “machine-storage medium” refers to a single or multiple storage devices and/or media (e.g., a centralized or distributed database, and/or associated caches and servers) that store executable instructions, routines and/or data. The term includes, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, some of which are covered under the term “signal medium.”

A “processor” refers to any circuit or virtual circuit (a physical circuit emulated by logic executing on an actual processor) that manipulates data values according to control signals (e.g., “commands”, “op codes”, “machine code”, and so forth) and which produces associated output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

A “signal medium” refers to any intangible medium that is capable of storing, encoding, or carrying the instructions for execution by a machine and includes digital or analog communications signals or other intangible media to facilitate communication of software or data. The term “signal medium” may be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

A “kernel” or “microkernel” are implementations of an algorithm that does computation against memory objects like memory buffers of a certain layout. The two terms may be used interchangeably, but “microkernel” tends to connote a small operation (e.g., memset, dot product or reduction) within a larger generator kernel implementation. Algorithmically interchangeable/equivalent/replaceable kernels are sometimes referred to as “codelets” in literature.

A “generator” is a meta program that is parameterized and is executed to generate a non-parametric implementation of a kernel or microkernel. Fixed kernel implementations (e.g., a panel dot product implemented in assembly) are a degenerate case of a generator with no parameters.

A “kernel interface declaration” is a declaration of kernel or microkernel that applies to multiple implementations of a kernel or microkernel. Kernels and microkernels may be implemented multiple times in multiple different ways. An interface declaration can stand alone from the implementations, allowing clients and implementations to be type checked.

A “generator parameter argument” refers to a value that a kernel or a microkernel is allowed to act on. A generator is a meta program that generates a kernel, and “parameters” are the values that this meta program is allowed to act on.

A “kernel generator parameter result” is a value returned by a generator to its invoker as parameters, allowing them to adapt to behavior in the generated sub-kernel. For example, a panel dot product generator could return “I processed a 3×5 panel of memory”, which causes the invoking for loop to step by 3 and 5 on each dimension.

A “generator constraint” is a constraint indicating limitations on parameters of a kernel or microkernel, e.g., “this implementation only works with dtype=float32”, or “this only works on machines with X86 VNNI extension”, this “works for sizes modulo 136” and the like.—Generators are allowed to be partial generators from the interface declaration to a concrete implementation. Constraints are upward propagated from kernel implementations out to the generator graph.

A “kernel argument” is a Static Single Assignment (SSA) argument value used for: buffers and other user defined types for structured abstractions over memory, like linear memory, N-dimensional tensors with layouts, and other higher level data types like trees and tables; the values corresponding to op attributes in the tensor graph level, while they may be modeled as constants there, they are dynamic values for the runtime implementation of the kernel; and very small micro kernels at the bottom of the stack (e.g., add two integers) use arguments for their inputs.

A “kernel result” is a SSA result value used for: dynamically allocated result buffers, e.g., those that have data dependent shapes; and very small micro kernels at the bottom of the stack (e.g., add two integers) use results for their outputs.

What is claimed is:

1. A computer-implemented method, comprising:
receiving a multi-layered computational graph comprising a modular operation graph, the modular operation graph comprising a set of modular operations;
generating a first modular operation generator graph using the modular operation graph and one or more sets of kernels;
generating a second modular operation generator graph comprising one or more fused operations by performing one or more fusions of two or more operations of the modular operation generator graph; and
generating an executable object using the second modular operation generator graph comprising the one or more fused operations.

2. The computer-implemented method of claim 1, wherein generating the second modular operation generator graph comprises:
selecting kernels from a set of system kernels and a set of user supplied kernels using definitions of the set of modular operations of the modular operation graph.

3. The computer-implemented method of claim 1, wherein selecting the kernels further uses metadata of a set of user supplied kernels.

4. The computer-implemented method of claim 1, wherein a kernel of a set of user supplied kernels is treated as a first class object during a compilation process.

5. The computer-implemented method of claim 1, wherein an operation of the first modular operation generator graph comprises one or more prologue functions defining a loading of input data into the operation.

6. The computer-implemented method of claim 1, wherein an operation of the first modular operation generator graph comprises one or more epilogue functions defining a writing of output data of the operation.

7. A machine, comprising:
at least one processor; and
at least one memory storing instructions that, when executed by the at least one processor, cause the machine to perform operations comprising:
receiving a multi-layered computational graph comprising a modular operation graph, the modular operation graph comprising a set of modular operations;
generating a first modular operation generator graph using the modular operation graph and one or more sets of kernels;
generating a second modular operation generator graph comprising one or more fused operations by performing one or more fusions of two or more operations of the modular operation generator graph; and
generating an executable object using the second modular operation generator graph comprising the one or more fused operations.

8. The machine of claim 7, wherein generating the first modular operation generator graph comprises:
selecting kernels from a set of system kernels and a set of user supplied kernels using definitions of the set of modular operations of the modular operation graph.

9. The machine of claim 7, wherein selecting the kernels further uses metadata of a set of user supplied kernels.

10. The machine of claim 7, wherein, wherein a kernel of a set of user supplied kernels is treated as a first class object during a compilation process.

11. The machine of claim 7, wherein, wherein an operation of the first modular operation generator graph comprises one or more prologue functions defining a loading of input data into the operation.

12. The machine of claim 7, wherein, wherein an operation of the first modular operation generator graph comprises one or more epilogue functions defining a writing of output data of the operation.

13. A machine-storage medium storing instructions that, when executed by a machine, cause the machine to perform operations comprising:
receiving a multi-layered computational graph comprising a modular operation graph, the modular operation graph comprising a set of modular operations;
receiving a multi-layered computational graph comprising a modular operation graph, the modular operation graph comprising a set of modular operations;
generating a first modular operation generator graph using the modular operation graph and one or more sets of kernels;
generating a second modular operation generator graph comprising one or more fused operations by performing one or more fusions of two or more operations of the modular operation generator graph; and
generating an executable object using the second modular operation generator graph comprising the one or more fused operations.

14. The machine-storage medium of claim 13, wherein generating the first modular operation generator graph comprises:
selecting kernels from a set of system kernels and a set of user supplied kernels using definitions of the set of modular operations of the modular operation graph.

15. The machine-storage medium of claim 13, wherein, wherein a kernel of a set of user supplied kernels is treated as a first class object during a compilation process.

16. The machine-storage medium of claim 13, wherein selecting the kernels further uses metadata of a set of user supplied kernels.

17. The machine-storage medium of claim 13, wherein an operation of the modular operation generator graph comprises one or more prologue functions defining a loading of input data into the operation.

18. The machine-storage medium of claim 13, wherein, wherein an operation of the modular operation generator graph comprises one or more epilogue functions defining a writing of output data of the operation.
